(19) United States
(12) Patent Application Publication
(10) Pub. No.: US 2011/0013731 A1
(43) Pub. Date: Jan. 20, 2011

(54) SPECTRUM SENSING FOR DMB-T SYSTEMS USING PN FRAME HEADERS

(75) Inventors: Hou-Shin Chen, Edison, NJ (US); Wen Gao, West Windsor, NJ (US)

Correspondence Address: Robert D. Shedd, Patent Operations;THOMSON Licensing LLC, P.O. Box 5312, Princeton, NJ, 08543-5312, US

(73) Assignee: Thomson Licensing LLC, Princeton, NJ (US)

(21) Appl. No.: 12/733,568

(22) PCT Filed: Jul. 23, 2008
(86) PCT No.: PCT/US08/08926

§ 371 Date: Mar. 9, 2010

Related U.S. Application Data
(60) Provisional application No. 60/995,781, filed on Sep. 28, 2007.

(51) Int. Cl. H04L 27/06

(52) U.S. Cl. 375/343

(57) ABSTRACT

This dissertation addresses the intersection of personal wireless technology and computational intelligence. The primary research issue addressed is the organization of radio domain knowledge into data structures processable in real-time that integrate machine learning and natural language processing technology into software radio. The thesis defines and develops the cognitive radio architecture. The features needed in the architecture are derived from cognitive radio use cases. These include inferring user communications context, shaping access-network demand, and realizing a protocol for real-time radio spectrum rental. Mathematical foundations for the knowledge-representation architecture are derived by applying point-set topology to the requirements of the use cases. This results in the set-theoretic ontology of radio knowledge defined in the Radio Knowledge Representation Language (RKRL). The mathematical analysis also demonstrates that isochronous radio software is not Turing-computable. Instead, it is constrained to a bounded-recursive subset of the total functions. A rapid-prototype cognitive radio, CR1, was developed to apply these mathematical foundations in a simulated environment. CR1 demonstrated the principles of cognitive radio and focused the research issues. This led to an important contribution of this dissertation, the cognitive radio architecture. This is an open architecture framework for integrating agent-based control, natural language processing, and machine learning technology into software-defined radio platforms.

### CROSS-REFERENCE TO RELATED APPLICATIONS

This application claims the benefit of U.S. Provisional Application No. 60/995,781, filed Sep. 28, 2007.

### BACKGROUND OF THE INVENTION

The present invention generally relates to communications systems and, more particularly, to wireless systems, e.g., terrestrial broadcast, cellular, Wireless-Fidelity (Wi-Fi), satellite, etc.

A Wireless Regional Area Network (WRAN) system is being studied in the IEEE 802.22 standard group. The WRAN system is intended to make use of unused television (TV) broadcast channels in the TV spectrum, on a non-interfering basis, to address, as a primary objective, rural and remote areas and low population density underserved markets with performance levels similar to those of broadband access technologies serving urban and suburban areas. In addition, the WRAN system may also be able to scale to serve denser population areas where spectrum is available. Since one goal of the WRAN system is not to interfere with TV broadcasts, a critical procedure is to robustly and accurately sense the licensed TV signals that exist in the area served by the WRAN (the WRAN area).

In the United States, the TV spectrum currently comprises ATSC (Advanced Television Systems Committee) broadcast signals that co-exist with NTSC (National Television Systems Committee) broadcast signals. The ATSC broadcast signals are also referred to as digital TV (DTV) signals. Currently, NTSC transmission will cease in 2009 and, at that time, the TV spectrum will comprise only ATSC broadcast signals. However, in some areas of the world, instead of ATSC-based transmission, DVB (Digital Video Broadcasting)-based transmission may be used. For example, DTV signals may be transmitted using DVB-T (Terrestrial) (e.g., see ETSI EN 300 744 V1.4.1 (2001-01), Digital Video Broadcasting (DVB); Framing structure, channel coding and modulation for digital terrestrial television). DVB-T uses a form of a multi-carrier transmission, i.e., DVB-T is OFDM (orthogonal frequency division multiplexing)-based.

In addition to DVB-T, DTV signals in China are specified by the NSPRC Digital Multimedia Broadcasting-Terrestrial (DMB-T) Standard (“Framing Structure, Channel Coding and Modulation for Digital Television Terrestrial Broadcasting System,” NSPRC, August 2007). In DMB-T systems, a time-domain synchronous OFDM (TDS-OFDM) technique is adopted.

Since, as noted above, one goal of the WRAN system is to not interfere with those TV signals that exist in a particular WRAN area, it is important in a WRAN system to be able to detect DMB-T broadcasts (licensed signals) in a very low signal to noise ratio (SNR) environment.

### SUMMARY OF THE INVENTION

A DMB-T signal comprises signal frames. A signal frame comprises a frame header and a frame body. There are three frame header modes (modes) defined in the DMB-T Standard and the structure for each mode is different. The frame headers of the different modes include pseudonoise (PN) sequences, which are inserted as guard intervals instead of cyclic prefixes as found in typical OFDM transmission such as the above-mentioned DVB-T. Notwithstanding the different structures for the different modes, and in accordance with the principles of the invention, a receiver performs spectrum sensing for possible DMB-T signals in the area by selecting one of a number of channels; and searching for a signal on the selected channel, the signal being formatted in accordance with one of a plurality of frame structures, each frame structure having a different frame header mode comprising a pseudonoise sequence and a frame body comprising data; wherein the searching step searches for the pseudonoise sequence in each of the frame header modes for determining if the signal is present on the selected channel.

In an illustrative embodiment of the invention, the receiver is a Wireless Regional Area Network (WRAN) endpoint, and the type of signal the receiver is searching for is a DMB-T signal having at least three different frame structures.

In view of the above, and as will be apparent from reading the detailed description, other embodiments and features are also possible and fall within the principles of the invention.

### BRIEF DESCRIPTION OF THE DRAWINGS

FIGS. 1 and 2 show a DMB-T frames and DMB-T frame headers;

FIG. 3 shows an illustrative WRAN system in accordance with the principles of the invention;

FIGS. 4-9 show illustrative flow charts in accordance with the principles of the invention for use in the WRAN system of FIG. 3; and

FIGS. 10-14 shows spectrum sensing performance graphs for the various methods described herein.

### DETAILED DESCRIPTION

Other than the inventive concept, the elements shown in the figures are well known and will not be described in detail. Also, familiarity with television broadcasting, receivers and video encoding is assumed and is not described in detail herein. For example, other than the inventive concept, familiarity with current and proposed recommendations for TV standards such as NTSC (National Television Systems Committee), PAL (Phase Alternating Lines), SECAM (SEquential Couleur Avec Memoire), ATSC (Advanced Television Systems Committee), Chinese Digital Television System (GB) 20600-2006 and networking, such as IEEE 802.16, 802.11h, etc., is assumed. Further information on DVB-T broadcast signals can be found in, e.g., ETSI EN 300 744 V1.4.1 (2001-01), Digital Video Broadcasting (DVB); Framing structure, channel coding and modulation for digital terrestrial television. Likewise, other than the inventive concept, transmission concepts such as eight-level vestigial sideband (8-VSB), Quadrature Amplitude Modulation (QAM), orthogonal frequency division multiplexing (OFDM) or coded OFDM (COFDM)) or discrete multitone (DMT), and receiver components such as a radio-frequency (RF) front-end, or receiver section, such as a low noise block, tuners, and demodulators, correlators, leak integrators and squarers is assumed. Similarly, other than the inventive concept, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the figures represent similar elements.

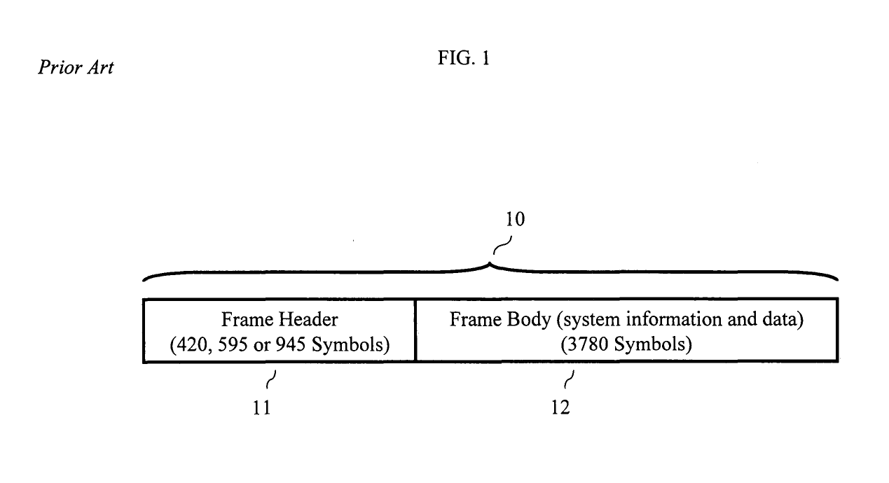

In the currently proposed Chinese Digital Television System, NSPRC Digital Multimedia Broadcasting-Terrestrial (DMB-T) Standard (“Framing Structure, Channel Coding and Modulation for Digital Television Terrestrial Broadcasting System,” NSPRC, August 2007) specifies a receiver support a single carrier (SC) modulation mode and a orthogonal frequency division multiplexing (OFDM) modulation mode. In DMB-T systems, a time-domain synchronous OFDM (TDS-OFDM) technique is adopted. The DMB-T signal comprises a hierarchical frame structure with signal frames providing the basic building block. A signal frame 10 is shown in FIG. 1. Signal frame 10 comprises a frame header 11 and a frame body 12. Frame header 11 has three frame header modes of different lengths. As can be observed from FIG. 1, these lengths are 420, 595 or 945 symbols. Frame body 12 conveys 3780 symbols, of which 36 symbols are system information and 3744 symbols are data. The frame headers include pseudonoise (PN) sequences that serve as pilot signals and which are also used as guard intervals instead of cyclic prefixes as found in typical OFDM transmission such as the above-mentioned DVB-T.

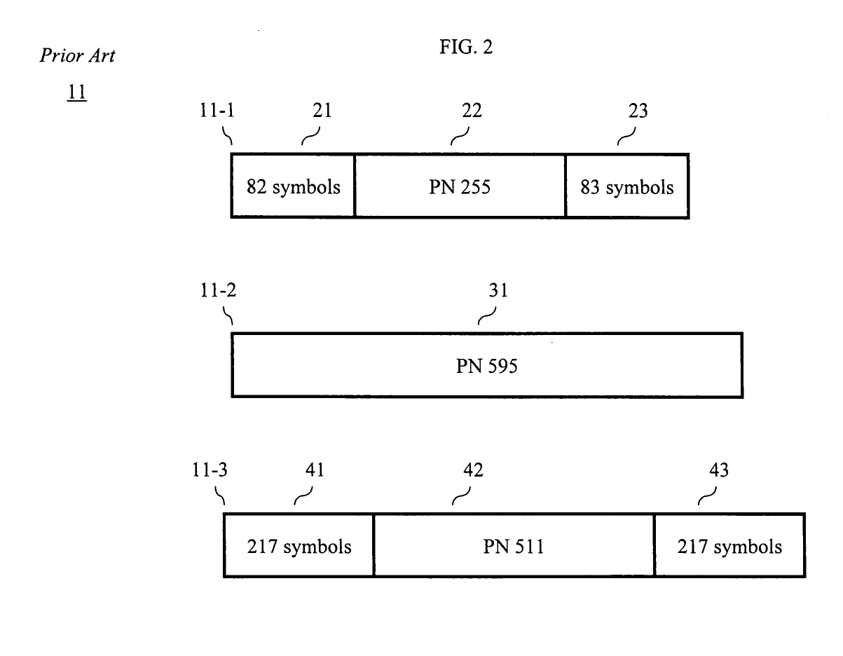

The three different frame header modes are shown in FIG. 2. Frame header mode 1 (11-1) comprises a front synchronization portion (21), a PN255 sequence portion (22) and a rear synchronization portion (23). The front (21) and rear (23) synchronizations are cyclic extensions of the PN255 sequence (22). The length of the front synchronization is 82 symbols and the length of the rear synchronization is 83 symbols. For frame header mode 1, a group of 225 signal frames form a superframe (not shown) and these 225 frames use PN sequences generated by the same 8th-order linear shift register but have different initial phases. Frame header mode 2 (11-2) comprises a PN595 sequence, which is truncated from a 10th-order maximum length sequence. For example, frame header mode 2 (11-2) is made up of the first 595 symbols from a PN sequence of length 1023. For frame header mode 2, a group of 216 signal frames form a superframe. Unlike frame header mode 1, all frame headers contain the same PN595 sequence. Finally, frame header mode 3 (11-3) is similar to the structure of frame header mode 1 (11-1). Frame header mode 3 comprises a front synchronization (41), a PN511 sequence (42) and a rear synchronization (43). The front (41) and rear (43) synchronizations are cyclic extensions of the PN511 sequence (42). The length of the front synchronization is 217 symbols and the length of the rear synchronization is 217 symbols. For frame header mode 3, a group of 200 signal frames form a superframe and these 200 frames use PN sequences generated by the same 9th-order linear shift register having different initial phases.

As noted earlier, a WRAN system makes use of unused broadcast channels in the spectrum. In this regard, the WRAN system performs channel sensing, or spectrum sensing, to determine which of these broadcast channels are actually active (or “incumbent”) in the WRAN area in order to determine that portion of the spectrum that is actually available for use by the WRAN system. In this example, it is assumed that each broadcast channel may be associated with a corresponding DMB-T broadcast signal. Although a DMB-T signal may be transmitted in accordance with any one of a number of frame header modes, we have observed that it is still possible to efficiently detect the presence of a DMB-T signal by searching for the PN sequences embedded in the frame headers of the DMB-T signal. In particular, and in accordance with the principles of the invention, a receiver performs spectrum sensing for possible DMB-T signals in the area by selecting one of a number of channels; and searching for a signal on the selected channel, the signal being formatted in accordance with one of a plurality of frame structures, each frame structure having a different frame header mode comprising a pseudonoise sequence and a frame body comprising data; wherein the searching step searches for the pseudonoise sequence in each of the frame header modes for determining if the signal is present on the selected channel.

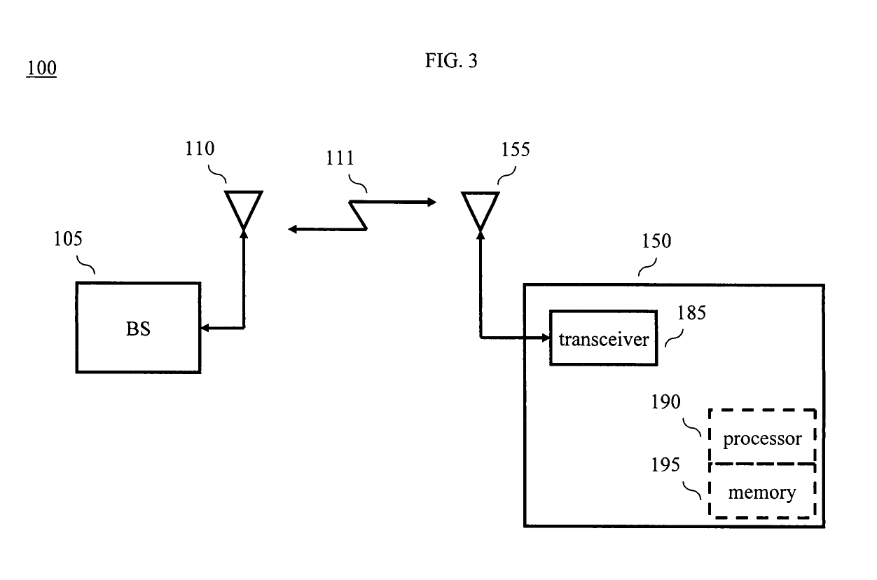

Referring now to FIG. 3, an illustrative Wireless Regional Area Network (WRAN) system 100 incorporating the principles of the invention is shown. WRAN system 100 serves a geographical area (the WRAN area) (not shown in FIG. 3). In general terms, a WRAN system comprises at least one base station (BS) 105 that communicates with one, or more, customer premise equipment (CPE) 150. The latter may be stationary. Both CPE 150 and BS 105 are representative of wireless endpoints. CPE 150 is a processor-based system and includes one, or more, processors and associated memory as represented by processor 190 and memory 195 shown in the form of dashed boxes in FIG. 3. In this context, computer programs, or software, are stored in memory 195 for execution by processor 190. The latter is representative of one, or more, stored-program control processors and these do not have to be dedicated to the transceiver function, e.g., processor 190 may also control other functions of CPE 150. Memory 195 is representative of any storage device, e.g., random-access memory (RAM), read-only memory (ROM), etc.; may be internal and/or external to CPE 150; and is volatile and/or non-volatile as necessary. The physical layer of communication between BS 105 and CPE 150, via antennas 110 and 155, is illustratively OFDM-based via transceiver 185 and is represented by arrows 111. To enter a WRAN network, CPE 150 first attempts to “associate” with BS 105. During this attempt, CPE 150 transmits information, via transceiver 185, on the capability of CPE 150 to BS 105 via a control channel (not shown). The reported capability includes, e.g., minimum and maximum transmission power, and a supported, or available, channel list for transmission and receiving. In this regard, CPE 150 performs channel sensing, or spectrum sensing, in accordance with the principles of the invention to determine which TV channels are not active in the WRAN area. The resulting available channel list for use in WRAN communications is then provided to BS 105. The latter uses the above-described reported information to decide whether to allow CPE 150 to associate with BS 105.

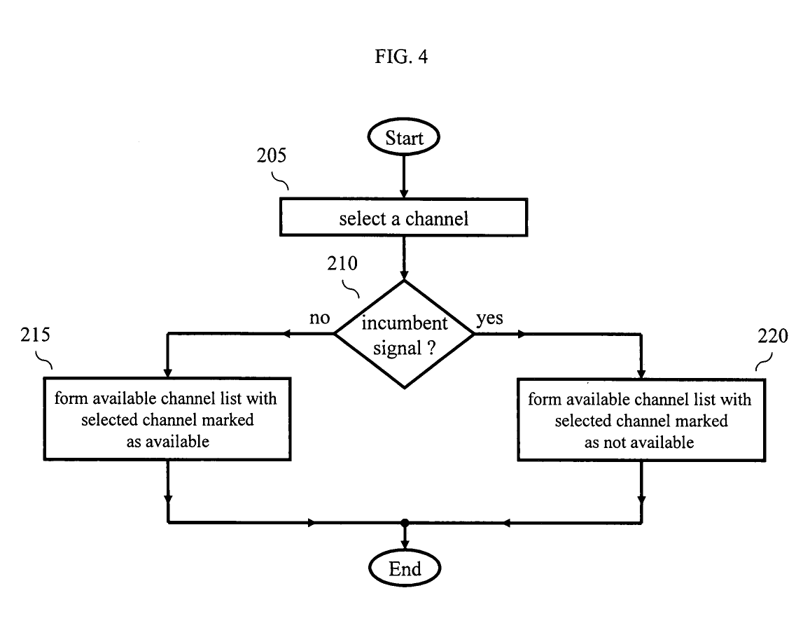

Turning now to FIG. 4, an illustrative flow chart for use in performing channel sensing in accordance with the principles of the invention is shown. The flow chart of FIG. 4 can be performed by CPE 150 over all of the channels, or only over those channels that CPE 150 has selected for possible use. Preferably, in order to detect incumbent signals in a channel, CPE 150 should cease transmission in that channel during the detection period. In this regard, BS 105 may schedule a quiet interval by sending a control message (not shown) to CPE 150. In step 205, CPE 150 selects a channel (e.g., via transceiver 185 of FIG. 3). In this example, the channel is assumed to be one of a number of broadcast channels present in the WRAN area. In step 210, CPE 150 scans the selected channel to check for the existence of an incumbent signal. In particular, CPE 150 determines if the received signal is a type of signal (e.g., a DMB-T signal) by searching for the PN sequences embedded in the frame headers of possible DMB-T signals (described further below). If no incumbent signal has been detected, then, in step 215, CPE 150 indicates the selected channel as available for use by the WRAN system on an available channel list (also referred to as a frequency usage map). However, if an incumbent signal is detected, then, in step 220, CPE 150 marks the selected channel as not available for use by the WRAN system. As used herein, a frequency usage map is simply a data structure stored in, e.g., memory 195 of FIG. 3, that identifies one, or more, channels, and parts thereof, as available or not for use in the WRAN system of FIG. 3. It should be noted that marking a channel as available or not can be done in any number of ways. For example, the available channel list may only list those channel that are available, thus effectively indicating other channels as not available. Similarly, the available channel list may only indicate those channels that are not available, thus effectively indicating other channels as available.

In terms of performing spectrum sensing by searching for the PN sequence embedded in the frame headers, frame header mode 2 is first described. For frame header mode 2, all frame headers contain the same PN595 sequence. As such, since the PN595 sequence is only a part of the whole PN sequence as noted earlier, it is difficult to use any property related to PN sequences to perform spectrum sensing. As a result, the correlation of a PN595 in two consecutive received frame headers is used as the basic approach to perform spectrum sensing for frame header mode 2. This is referred to herein as the PN Correlation (PNC) method. Let

r[n]=y[n]+ω[n]; (1)

where r[n] is the samples of the received signal at different sample index n, y[n] is the transmitted signal and ω[n] is additive white Gaussian noise (AWGN). It is assumed that ω[n] is a complex circularly symmetric Gaussian random variable which has zero-mean and a variance of σ²_{ω}. Since every frame header contains the same PN595 sequence, it can be expected that the correlation of two consecutive frame headers will generate a peak amplitude. Following this approach, the following decision statistic is defined for the PNC method for frame header mode 2:

$$\begin{matrix}{T}_{pnc , 2} = {max}_{0 \leq m \leq {M}_{2} - 1} \vert {t}_{pnc , 2} ( m ) \vert ; \\ where & ( 2 ) \\ {t}_{pnc , 2} ( m ) = \frac{1}{{S}_{2} {L}_{2}} {\sum }_{n = 0}^{{S}_{2} - 1} {\sum }_{k = 0}^{{L}_{2} - 1} r [ m + k + {nM}_{2} ] \cdot {r}^{*} [ m + k + ( n + 1 ) {M}_{2} ] . & ( 3 )\end{matrix}$$

The parameter M₂=N+L₂ is the length of a signal frame for frame header mode 2, where L₂ is the size of the frame header (595 symbols) and N is the size of the frame body (3780 symbols); and S₂ is the number of signal frames used to perform spectrum sensing.

It should be noted that in equation (2), because the timing information is lacking, M₂ possible initial frame sampling instances are tried. The maximum amplitude over all trials is used as a decision statistic. The detector defined in equation (2) is suboptimal compared to the detector with perfect timing information. However, the performance of the operating detector defined in equation (2) is bounded by the performance of the detector with perfect timing information. As such, this can be used to derive a lower bound on the misdetection probability for all detectors described herein.

Before continuing with a description of detecting the other frame header modes in accordance with the principles of the invention, a general description and derivation of a misdetection probability is now provided. In particular, let t(n₀) be a decision statistic of a detector which uses n₀ as an initial frame sample time instance and assume that t(n₀) is a complex random variable. Let \hat{T}=|t(\hat{n}₀)|, where \hat{n}₀ is the correct initial frame sample time instance. Therefore, \hat{T} is the decision statistic of the detector with perfect timing information. Now, let \tilde{T} be the decision statistic of the detector that lacks timing information. Then, without the use of special conditions, an exhaustive search for all possible initial frame sample time instances is used. Thus, a detector having the decision statistic \tilde{T}=maxₙ_{₀}|t(n₀)| is the general detector structure when t(n₀) is used as the decision statistic and timing information is unavailable. The detection performance of \tilde{T} is bounded by the detection performance of \hat{T}. In this regard, it is assumed that the probability distribution functions for both hypothesis H₁ (signal plus noise) and H₀ (noise only) for t(\hat{n}₀) are given as

p_{t(ñ}_{₀}₎(t;H₁)˜CN(μ,σ₁²)

p_{t(ñ}_{₀}₎(t;H₀)˜CN(0,σ₀²) (4)

where CN(μ,σ₁²) denotes a complex Gaussian distribution with mean μ and variance σ². Therefore, the random variable \hat{T} is Rayleigh distributed for hypothesis H₀ and is Rician distributed for hypothesis H₁. Then, for a specific probability of false alarm P_{FA}, the corresponding threshold γ_{\hat{T}} is given by

γ_{\hat{T}}=\sqrt{−σ₀²lnP_{FA}} (5)

and the corresponding probability of misdetection probability P_{MD,\hat{T}} is given by

$${P}_{MD , \hat{T}} = 1 - {Q}_{{χ}_{2}^{′2} ( λ )} ( \frac{{γ}_{\hat{T}}^{2}}{{σ}_{1}^{2}} ) \qquad ( 6 )$$

where the function

$${Q}_{{χ}_{2}^{′2} ( λ )} ( x ) = {\int }_{x}^{∞} \frac{1}{2} exp [ \frac{- 1}{2} ( t + λ ) ] {I}_{0} ( \sqrt{λ t} ) d t \qquad ( 7 )$$

is the right-tail probability of the noncentral Chi-Squared distribution with two degrees of freedom and λ=|μ|²/σ₁². The function

$${I}_{0} ( u ) = {\int }_{0}^{2 π} exp ( u cos θ ) \frac{d θ}{2 π} \qquad ( 8 )$$

is the modified Bessel function of the first kind and order zero. Then, the misdetection probability calculated in equation (6) is a performance lower bound on the misdetection probability for the detector which uses \tilde{T} as a decision statistic.

Now, let \hat{T}_{pnc,2}=t_{npc,2}(\hat{m}₀)| where \hat{m}₀ is the correct initial frame sample time instance. Then, from the Central Limit Theorem, for sufficiently large S₂L₂, the probability distribution functions of t_{npc,2}(\hat{m}₀) for both hypothesis H₁ (signal plus noise) and H₀ (noise only) will approach circularly symmetric complex Gaussian distributions:

$${p}_{{t}_{pnc , 2} ( {\hat{m}}_{0} )} ( t ; {H}_{1} ) ∼ CN ( {σ}_{p}^{2} , \frac{2 {σ}_{p}^{2} {σ}_{w}^{2} + {σ}_{w}^{4}}{{S}_{2} {L}_{2}} ) \\ {p}_{{t}_{pnc , 2} ( {\hat{m}}_{0} )} ( t ; {H}_{0} ) ∼ CN ( 0 , \frac{{σ}_{w}^{4}}{{S}_{2} {L}_{2}} ) \qquad ( 9 )$$

where the parameter σₚ² is the average energy of the received signal frame header. Then by substituting the parameters of equation (9) into equations (5) and (6), a lower bound for the misdetection probability of the PNC detector can be obtained for frame header mode 2.

Turning now to frame headers modes 1 and 3, and referring briefly to FIG. 2, for these frame header modes, a frame header comprises a PN sequence and its cyclic extension. Thus, in frame header mode 1, the first 165 symbols of the frame header are a repetition of the last 165 symbols of the frame header. Likewise, in frame header mode 3, the first 434 symbols of the frame header are a repetition of the last 434 symbols of the frame header. For detection of frame header modes 1 and 3, a correlation of these two components is used to perform spectrum sensing. This is referred to herein as the cyclic extension correlation (CEC) method. In this regard, the following decision statistic for use in the CEC method is defined:

$$\begin{matrix}{T}_{cec , i} = {max}_{0 \leq m \leq {M}_{i}} \vert {t}_{cec , i} ( m ) \vert , i = 1 , 3 ; \\ with ; & ( 10 ) \\ {t}_{cec , i} ( m ) = \frac{1}{{S}_{i} {C}_{i}} {\sum }_{n = 0}^{{S}_{i} - 1} {\sum }_{k = 0}^{{C}_{i} - 1} r [ m + k + {nM}_{i} ] \cdot {r}^{*} [ m + k + {G}_{i} + {nM}_{i} ] , \\ i = 1 , 3 ; & ( 11 )\end{matrix}$$

where C₁=165 (C₃=434) is the number of the cyclic extended symbols and G₁=255 (G₃=511) is the length of the PN sequence for frame header mode 1 (mode 3). The parameter Mᵢ=N+Lᵢ is the length of a signal frame for frame header mode i, and i=1,3.

Similarly, with regard to a lower bound for misdetection probability, let \hat{T}_{cec,i}=|t_{cec,i}(\hat{m}₀)| where \hat{m}₀ is the correct initial frame sample time instance. Then, from the Central Limit Theorem, for sufficiently large SᵢCᵢ, the probability distribution functions of t_{cec,i}(\hat{m}₀) for both hypothesis H₁ and H₀ will approach complex Gaussian distributions:

$${p}_{{t}_{CEC , i} ( {\hat{m}}_{0} )} ( t ; {H}_{1} ) ∼ CN ( {σ}_{p}^{2} , \frac{2 {σ}_{p}^{2} {σ}_{w}^{2} + {σ}_{w}^{4}}{{S}_{i} {C}_{i}} ) \\ {p}_{{t}_{CEC , i} ( {\hat{m}}_{0} )} ( t ; {H}_{0} ) ∼ CN ( 0 , \frac{{σ}_{w}^{4}}{{S}_{i} Ci} ) \qquad ( 12 )$$

Again, by substituting the parameters of equation (12) into equations (5) and (6), a lower bound on the misdetection probability for the CEC detector for can be obtained frame header mode 1 and mode 3.

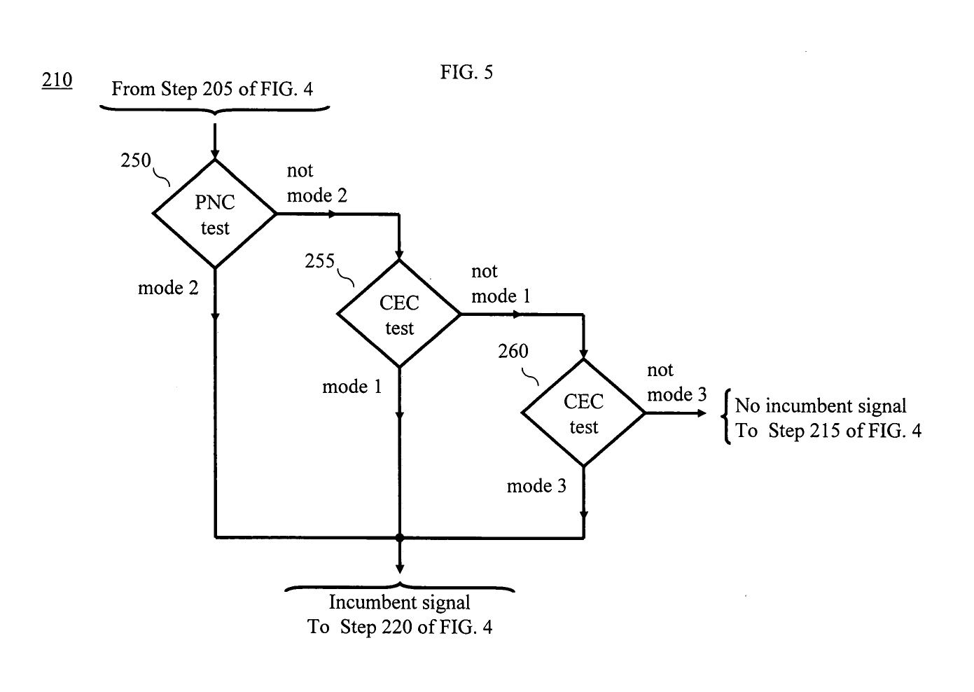

In view of the above, an illustrative flow chart for performing step 210 of FIG. 4 is shown in FIG. 5. In step 250, CPE 150 performs the PNC test for frame header mode 2. If a framer header mode 2 is not detected, then CPE 150 performs a CEC test for frame header mode 1 in step 255. Likewise, if a frame header mode 1 is not detected, CPE 150 then performs a CEC test for frame header mode 3 in step 260. If a frame header mode 3 is not detected, then no incumbent signal has been detected and execution proceeds with step 215 of FIG. 4, as described above. However, if in either steps 250, 255 or 260 the respective type of frame header was detected, then execution proceeds to step 220 of FIG. 4, as described above. It should be noted that although the frame header checks shown in FIG. 5 are conveniently shown in the same order as described earlier, this is not necessary and the frame header checks can be performed in any sequence in accordance with the principles of the invention.

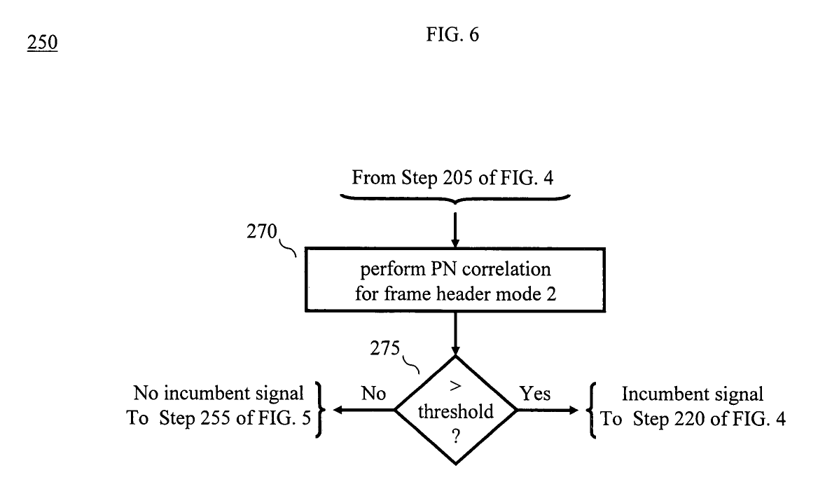

Turning now to FIG. 6, an illustrative flow chart for performing step 250 of FIG. 5 is shown. In step 270, the earlier described PNC method is performed for frame header mode 2. In particular, CPE 150 determines the maximum value (equation (2)) for T_{pnc,2} as described above and then compares the value of T_{pnc,2} to a threshold value (step 275), which may be determined experimentally. If the value of T_{pnc,2} is greater than the threshold value, then it is assumed that a DMB-T broadcast signal is present. However, if the value of T_{pnc,2} is not greater than the threshold value, then it is assumed that a DMB-T broadcast signal is not present.

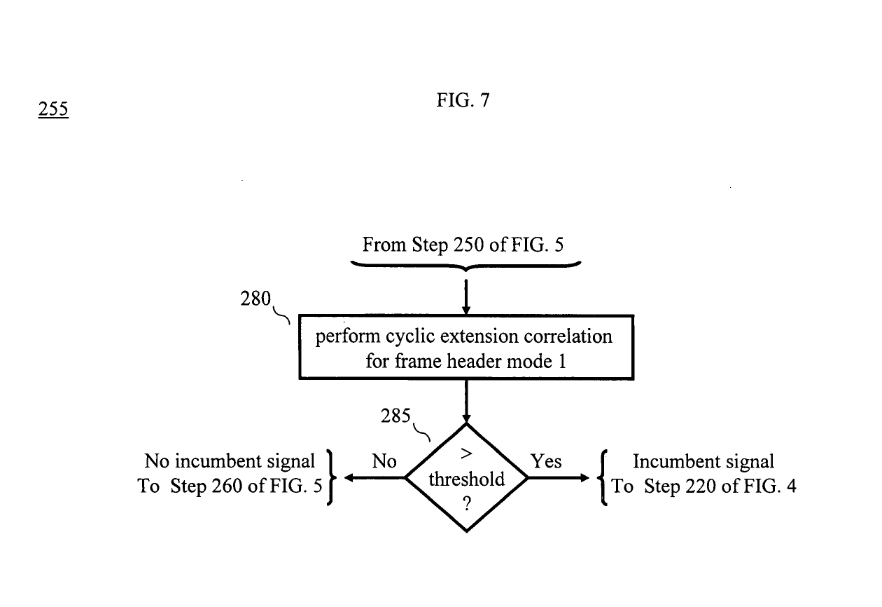

Referring now to FIG. 7, an illustrative flow chart for performing step 255 of FIG. 5 is shown. In step 280, the earlier described CEC method is performed for frame header mode 1. In particular, CPE 150 determines the maximum value (equation (10)) for T_{cec,1} as described above and then compares the value of T_{cec,1} to a threshold value (step 285), which may be determined experimentally. If the value of T_{cec,1} is greater than the threshold value, then it is assumed that a DMB-T broadcast signal is present. However, if the value of T_{cec,1} is not greater than the threshold value, then it is assumed that a DMB-T broadcast signal is not present.

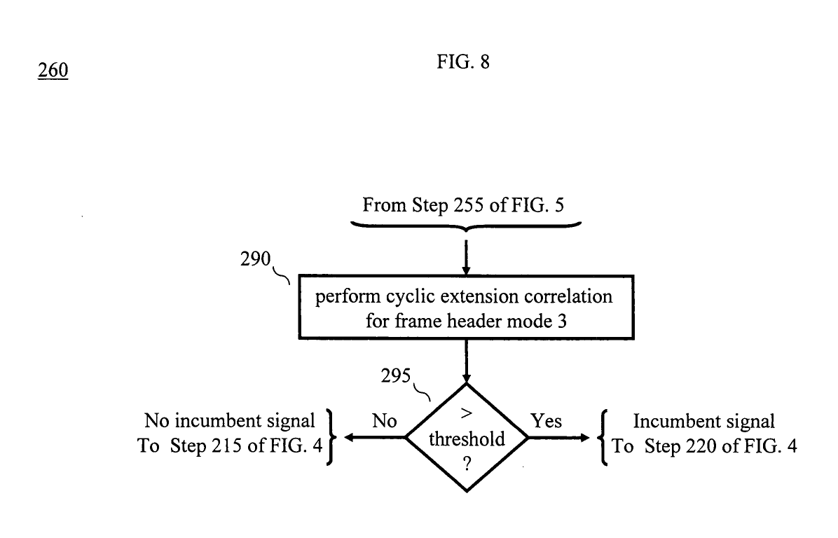

Continuing now to FIG. 8, an illustrative flow chart for performing step 260 of FIG. 5 is shown. In step 290, the earlier described CEC method is performed for frame header mode 3. In particular, CPE 150 determines the maximum value (equation (10)) for T_{cec,3} as described above and then compares the value of T_{cec,3} to a threshold value (step 295), which may be determined experimentally. If the value of T_{cec,3} is greater than the threshold value, then it is assumed that a DMB-T broadcast signal is present. However, if the value of T_{cec,3} is not greater than the threshold value, then it is assumed that a DMB-T broadcast signal is not present.

It should be noted that the PN correlation method for frame header mode 2 can also be applied to frame headers modes 1 and 3 instead of the above-described CEC method. For frame header modes 1 and 3, the signal frame headers in a superframe use PN sequences which are generated by the same linear shift register having different initial phases. These PN sequences are cyclic shifts of each other. The initial phases of the PN sequences for each signal frame of a superframe are listed in NSPRC, “Framing Structure, Channel Coding and Modulation for Digital Television Terrestrial Broadcasting System,” NSPRC, August 2007, mentioned earlier. After computer verification, we found that the PN sequences have the following structure. Let the PN sequence in the first signal frame be a reference PN sequence and Pᵢ(l) be the PN sequence which is cyclically right shifted by l places relative to the reference PN sequence for frame header mode i. Then for frame header mode l the following relationship holds:

$${F}_{1} ( l ) = \{ \begin{matrix}{P}_{1} ( l / 2 ) , & l = 0 , 2 , … , 112 \\ {P}_{1} ( 254 - ( l - 1 ) / 2 ) , & l = 1 , 3 , … , 111 \\ {F}_{1} ( 224 - l ) , & l = 113 , … , 224\end{matrix} \qquad ( 13 )$$

where F₁(l) is the PN sequence which is used in the l^{th} signal frame for frame header mode 1. In similar fashion, for frame header mode 3 the following relationship holds:

$${F}_{3} ( l ) = \{ \begin{matrix}{P}_{3} ( l / 2 ) , & l = 0 , 2 , 4 , … , 100 \\ {P}_{3} ( 510 - ( l - 1 ) / 2 ) , & l = 1 , 3 , 5 , … , 99 \\ {F}_{3} ( 200 - l ) , & l = 101 , 102 , … , 199\end{matrix} \qquad ( 14 )$$

where F₃(l) is the PN sequence which is used in the l^{th} signal frame for frame header mode 3.

Although the PN sequences used in signal frames of a superframe follow the rules given in equations (13) and (14) for frame header modes 1 and 3, respectively, it is still not easy to utilize the properties associated with the PN sequence and these rules to perform spectrum sensing using correlation of the PN sequence in frame header modes 1 and 3 because the PN sequence in every other signal frame is not always cyclically right shifted or left shifted. However, except for the two signal frames in the middle, the cyclic shift of the PN sequence for every other signal frame is either one place to the right or one place to the left. Therefore, the following decision statistic associated with the PNC method is defined for frame header mode 1 and frame header mode 3 as:

$$\begin{matrix}{T}_{pnc , i} = {max}_{0 \leq m \leq ⌈ {M}_{i} / {C}_{i} ⌉ - 1} \vert {t}_{pnc , i} ( m ) \vert ; \\ where & ( 15 ) \\ {t}_{pnc , i} ( m ) = \frac{1}{2 {S}_{i} {G}_{i}} {\sum }_{n = 0}^{{S}_{i} - 1} {\sum }_{a = 0}^{1} {\sum }_{k = 0}^{{G}_{i} - 1} r [ {mC}_{i} + k + {nM}_{i} ] \cdot {r}^{*} [ \begin{matrix}{m}_{i} {C}_{i} + k + \\ ( n + 2 ) {M}_{i} + \\ {( - 1 )}^{a}\end{matrix} ] , \\ i = 1 , 3 & ( 16 )\end{matrix}$$

It should be noted that because of the cyclic extension of the PN sequence in the frame header in frame header modes 1 and 3, that as long as the initial sample is taken from the first 165 (434) symbols for frame header mode 1 (mode 3), once can obtain the entire PN255 (PN511) sequence. Thus, instead of searching over M, possible initial frame sampling time instances, one only need to try ┌Mᵢ/Cᵢ┐ points which are uniformly separated by Cᵢ−1. In the above notation, the function ┌b┐ is the smallest integer which is larger than or equal to b. It is easily seen that one of these points will fall within the first 165 (434) symbols for frame header mode 1 (mode 3). For multipath channels, this approach is not completely correct. However, the performance will not degrade too much as long as the length of the cyclic extension is much larger than the root mean-square (RMS) delay-spread of the wireless channel.

Again, with regard to a lower bound for miss-detection probability, let \hat{T}_{pnc,i}=|t_{pnc,i}(\hat{m}₀)|, i=1,3 where \hat{m}₀ is the correct initial frame sample time instance. Then, from the Central Limit Theorem, for sufficiently large SᵢCᵢ, the probability distribution functions of t_{cec,i}(\hat{m}₀) for both hypothesis H₁ and H₀ will approach circularly symmetric complex Gaussian distributions

$${p}_{{t}_{PNC , i} ( {\hat{m}}_{0} )} ( t ; {H}_{1} ) = CN ( \frac{{σ}_{p}^{2}}{2} , \frac{{σ}_{p}^{2} + 4 {σ}_{p}^{2} {σ}_{w}^{2} + 2 {σ}_{w}^{4}}{4 {S}_{i} {G}_{i}} ) \\ {p}_{{t}_{PNC , i} ( {\hat{m}}_{0} )} ( t ; {H}_{0} ) = CN ( 0 , \frac{{σ}_{w}^{4}}{{S}_{i} {G}_{i}} ) \qquad ( 17 )$$

Then, by substituting the parameters of equation (17) into equation (6), one can obtain a lower bound on the misdetection probability for the PNC detector for frame header mode 1 and frame header mode 3.

Following the terminology that was used in deriving a lower bound on misdetection probability above, let t(n₀) be a decision statistic of a detector which uses n₀ as an initial frame sample time instance. For hypothesis H₀, which corresponds to the presence of noise only, the random variable t(n₀) is a circularly symmetric Gaussian random variable. The random variables t(n₀) for a period of time instances are identical but not necessarily independently distributed. Therefore the random variable \hat{T}=maxₙ_{₀}|t(n₀)| is jointly Rayleigh distributed. Although the joint Rayleigh distribution for more than four random variables with arbitrary covariance matrix is still an open research problem, a good approximation can be determined by assuming that the random variables t(n₀) are independent. Thus, for a specific probability of false alarm, P_{FA}, the corresponding threshold γ_{\hat{T}} is given by:

$${γ}_{\hat{T}} = {{ɛ}_{\hat{T}} ( {σ}_{0}^{2} ln \frac{1}{1 - {( 1 - {P}_{FA} )}^{1 / W}} )}^{1 / 2} \qquad ( 18 )$$

where ε_{\hat{T}} is an heuristic adjusting factor added artificially to account for the approximation of independence between the random variables, and W is the number of time instances tried.

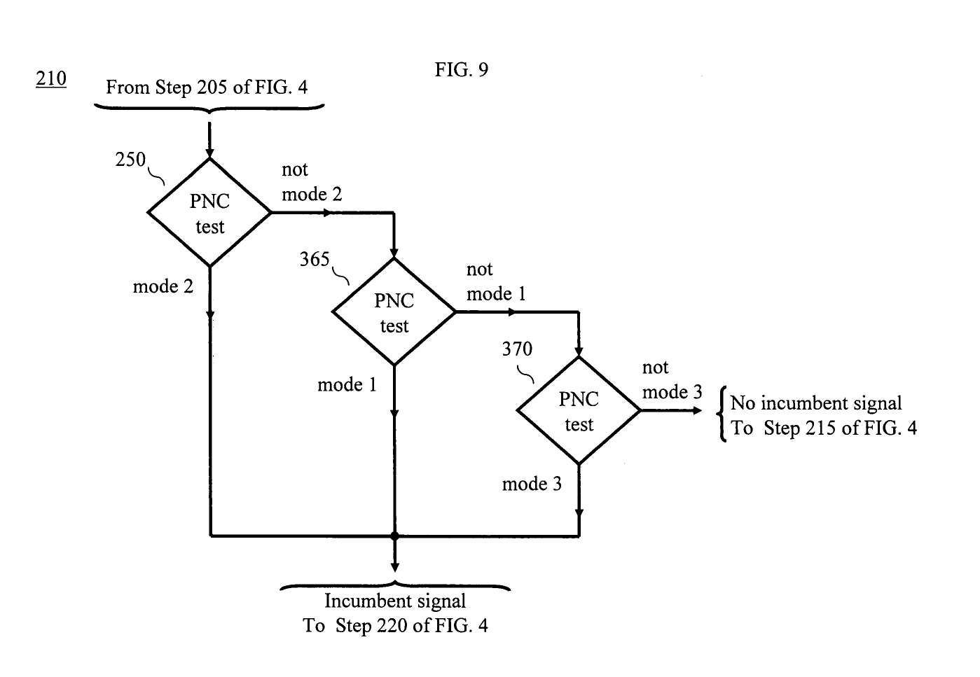

In view of the above, an illustrative flow chart for performing step 210 of FIG. 4 is shown in FIG. 9, where the PNC method is used for all three frame header modes. In step 250, CPE 150 performs the PNC test for frame header mode 2 as described above (and also shown in FIG. 6). If a framer header mode 2 is not detected, then CPE 150 performs a PNC test for frame header mode 1 in step 365, i.e., determines a value for T_{pnc,1}, (equation (15)) and compares this to a threshold value for determining if a frame header mode 1 has been detected. Likewise, if a frame header mode 1 is not detected, CPE 150 then performs a PNC test for frame header mode 3 in step 370, i.e., determines a value for T_{pnc,3}, (equation (15)) and compares this to a threshold value for determining if a frame header mode 3 has been detected. If a frame header mode 3 is not detected, then no incumbent signal has been detected and execution proceeds with step 215 of FIG. 4, as described above. However, if in either steps 250, 365 or 370 the respective type of frame header was detected, then execution proceeds to step 220 of FIG. 4, as described above. It again should be noted that although the frame header checks shown in FIG. 9 are conveniently shown in the same order as described earlier, this is not necessary and the frame header checks can be performed in any sequence in accordance with the principles of the invention.

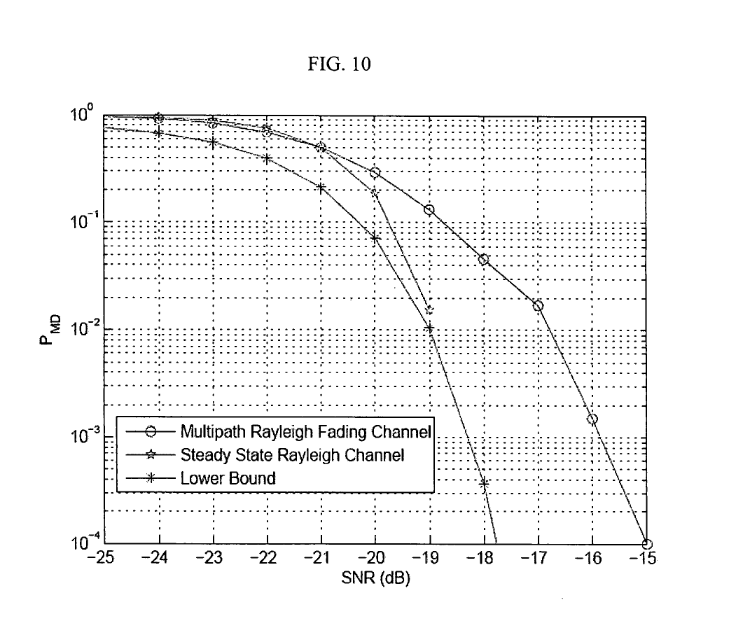

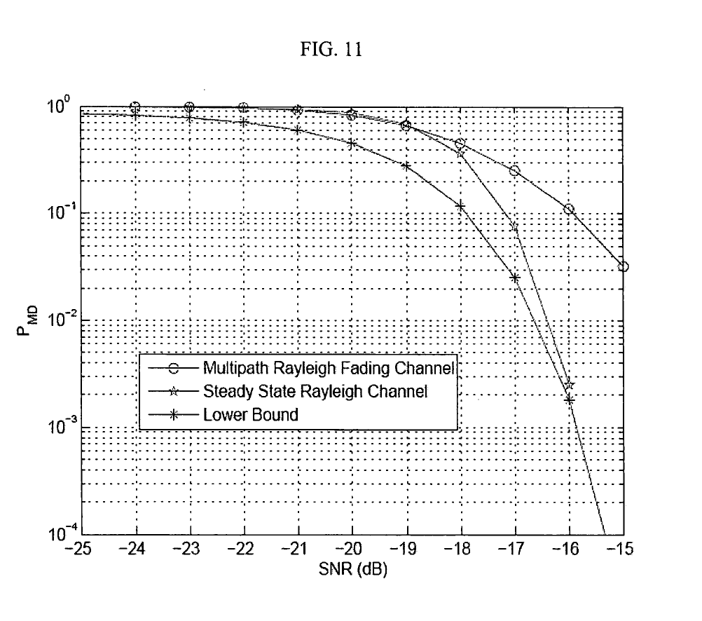

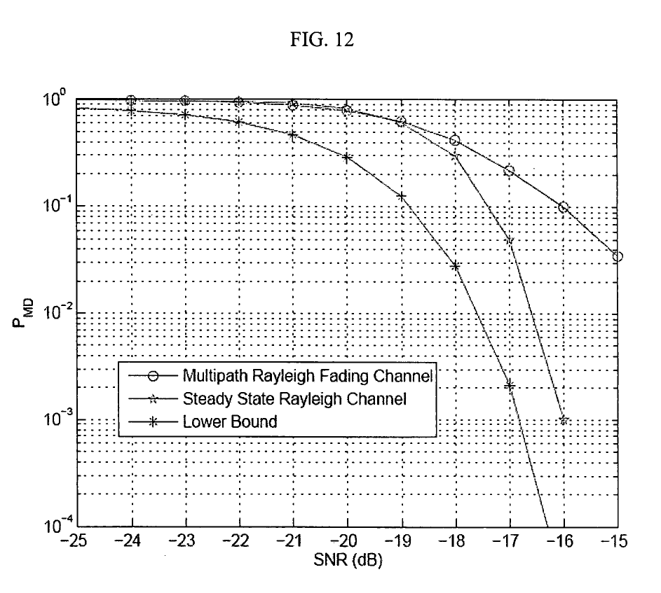

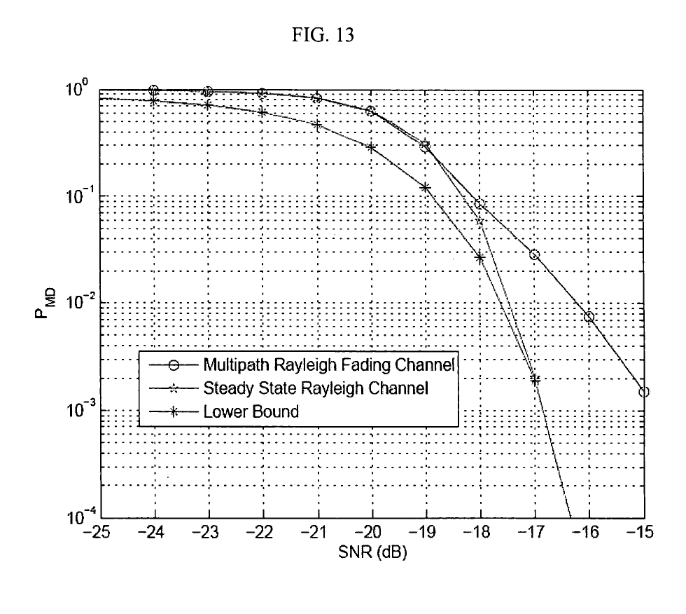

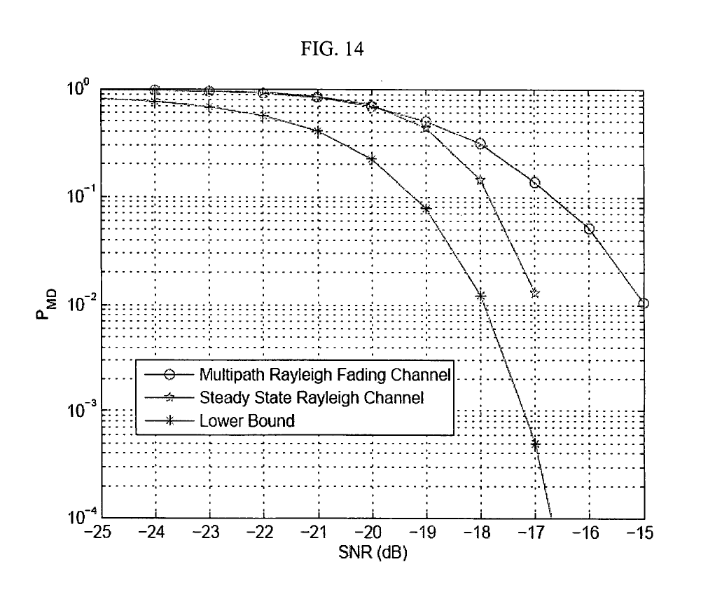

The performances of the proposed spectrum sensing methods described herein have been demonstrated via computer simulations. The probability of false alarm and sensing time are set to 0.01 and 50 ms, respectively. The simulated channel environments are the steady state multipath Rayleigh channel and multipath Rayleigh fading channel with root mean square (RMS) delay spread equal to 1.24 ls (9.37 samples). Here, each path of the steady state multipath Rayleigh fading channel is multiplied by a constant path gain. Thus, for each single path, its envelope is a constant and the Rayleigh fading occurs due to the sum of these paths. For the multipath Rayleigh fading channel, the envelope of each single path is Rayleigh distributed and the channel gains of each path are generated by Jakes fading model (e.g., see P. Dent, E. G. Bottomley, and T. Croft, “Jakes Fading Model Revisited,” Electronics Letters, Vol. 29, No. 13, pp. 1162-1163, June 1993). For frame header mode 2, as shown in FIG. 10, the probability of misdetection (P_{MD}) equal to 0.1 is achieved when the SNR is −18.8 dB for the multipath Rayleigh fading channel and −19.8 dB for the steady state channel. For frame header mode 1, as shown in FIGS. 11 (CEC method) and 12 (PNC method), the performances of the CEC and PNC methods are approximately the same. A P_{MD} equal to 0.1 is achieved when the SNR is −16 dB for multipath Rayleigh fading channel and −17.2 dB for the steady state channel. For frame header mode 3, as shown in FIGS. 13 (CEC method) and 14 (PNC method), the CEC method outperforms the PNC method. A P_{MD} equal to 0.1 is achieved when the SNR is −18.5 dB for the multipath Rayleigh fading channel and −18 dB for the steady state channel. In all FIGS. 10-14, the performance of the steady state channel is close to the theoretical lower bound indicating that the lower bound can be used as a good prediction of performance.

As described above, spectrum sensing for DMB-T systems is performed using PN frame headers. Simulation results show that the proposed spectrum sensors can work in very low SNR environments using only a sensing time of 50 ms. Furthermore, the lower bound on the misdetection probability described herein is a good prediction of the spectrum sensing performance.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Further, the principles of the invention are applicable to other types of communications systems, e.g., satellite, Wireless-Fidelity (Wi-Fi), cellular, etc. Indeed, the inventive concept is also applicable to stationary or mobile receivers. It is therefore to be understood that numerous modifications may be made to the illustrative embodiments and that other arrangements may be devised without departing from the spirit and scope of the present invention as defined by the appended claims.

1. A method for use in a receiver, the method comprising:
selecting one of a number of channels; and
searching for a signal on the selected channel, the signal being formatted in accordance with one of a plurality of frame structures, each frame structure having a different frame header mode comprising a pseudonoise sequence and a frame body comprising data;
wherein the searching step searches for the pseudonoise sequence in each of the frame header modes for determining if the signal is present on the selected channel.

2. The method of claim 1, wherein the signal is a Digital Multimedia Broadcasting-Terrestrial television signal.

3. The method of claim 1, wherein the plurality of frame structures is at least three,
wherein in the first frame structure, the frame header mode comprises a front synchronization portion, a pseudonoise sequence portion and a rear synchronization portion, where both the front synchronization portion and the rear synchronization portions are cyclic extensions of the pseudonoise sequence portion;
wherein in the second frame structure, the frame header mode comprises a pseudonoise sequence portion; and
wherein in the third frame structure, the frame header mode comprises a front synchronization portion, a pseudonoise sequence portion and a rear synchronization portion, where both the front synchronization portion and the rear synchronization portions are cyclic extensions of the pseudonoise sequence portion; and when the front synchronization portion, rear synchronization portion and pseudonoise sequence portion of the third frame structure are different from those of the first frame structure.

4. The method of claim 3, wherein the searching step comprises:
(a) searching for the first frame structure and the third frame structure by performing cyclic extension correlation; and
(b) searching for the second frame structure by performing pseudonoise correlation.

5. The method of claim 4, wherein steps (a) and (b) each comprise:
determining a decision statistic; and
comparing the decision statistic to a threshold for determining if the signal is present on selected channel.

6. The method of claim 5,
wherein for the first frame structure, the decision statistic is
$${T}_{cec , 1} = {max}_{0 \leq m \leq {M}_{1}} \vert {t}_{cec , 1} ( m ) \vert ;$$
wherein for the third frame structure, the decision statistic is
$${T}_{cec , 3} = {max}_{0 \leq m \leq {M}_{3}} \vert {t}_{cec , 3} ( m ) \vert ; and$$
wherein for the second frame structure. the decision statistic is
$${T}_{pnc , 2} = {max}_{0 \leq m \leq {M}_{2} - 1} \vert {t}_{pnc , 2} ( m ) \vert .$$

7. The method of claim 3, wherein the searching step comprises:
searching for each of the frame structures by performing pseudonoise correlation.

8. The method of claim 7, wherein the searching step comprises:
determining a decision statistic; and
comparing the decision statistic to a threshold for determining if the signal is present on selected channel.

9. The method of claim 8,
wherein for the first frame structure, the decision statistic is
$${T}_{pnc , 1} = {max}_{0 \leq m \leq ⌈ {M}_{1} / {C}_{i} ⌉ - 1} \vert {t}_{pnc , 1} ( m ) \vert ;$$
wherein for the third frame structure, the decision statistic is
$${T}_{pnc , 3} = {max}_{0 \leq m \leq ⌈ {M}_{3} / {C}_{i} ⌉ - 1} \vert {t}_{pnc , 3} ( m ) \vert ; and$$
wherein for the second frame structure, the decision statistic is
$${T}_{pnc , 2} = {max}_{0 \leq m \leq {M}_{2} - 1} \vert {t}_{pnc , 2} ( m ) \vert .$$

10. The method of claim 1, further comprising the step of:
marking an available channel list to indicate that the selected channel is available for use if no incumbent signal is present.

11. Apparatus comprising:
a transceiver for use in selecting one of a number of channels; and
a processor for use searching for a signal on the selected channel, the signal being formatted in accordance with one of a plurality of frame structures, each frame structure having a different frame header mode comprising a pseudonoise sequence and a frame body comprising data;
wherein the processor searches for the pseudonoise sequence in each of the frame header modes for determining if the signal is present on the selected channel.

12. The apparatus of claim 11, wherein the signal is a Digital Multimedia Broadcasting-Terrestrial television signal.

13. The apparatus of claim 11, wherein the plurality of frame structures is at least three,
wherein in the first frame structure, the frame header mode comprises a front synchronization portion, a pseudonoise sequence portion and a rear synchronization portion, where both the front synchronization portion and the rear synchronization portions are cyclic extensions of the pseudonoise sequence portion;
wherein in the second frame structure, the frame header mode comprises a pseudonoise sequence portion; and
wherein in the third frame structure, the frame header mode comprises a front synchronization portion, a pseudonoise sequence portion and a rear synchronization portion, where both the front synchronization portion and the rear synchronization portions are cyclic extensions of the pseudonoise sequence portion; and when the front synchronization portion, rear synchronization portion and pseudonoise sequence portion of the third frame structure are different from those of the first frame structure.

14. The apparatus of claim 13, wherein the processor (a) searches for the first frame structure and the third frame structure by performing cyclic extension correlation; and (b) searches for the second frame structure by performing pseudonoise correlation.

15. The apparatus of claim 14, wherein the processor determines a decision statistic for each frame structure and compare the decision statistic to a threshold for determining if the signal is present on selected channel.

16. The apparatus of claim 15,
wherein for the first frame structure, the decision statistic is
$${T}_{cec , 1} = {max}_{0 \leq m \leq {M}_{1}} \vert {t}_{cec , 1} ( m ) \vert ;$$
wherein for the third frame structure, the decision statistic is
$${T}_{cec , 3} = {max}_{0 \leq m \leq {M}_{3}} \vert {t}_{cec , 3} ( m ) \vert ; and$$
wherein for the second frame structure, the decision statistic is
$${T}_{pnc , 2} = {max}_{0 \leq m \leq {M}_{2} - 1} \vert {t}_{pnc , 2} ( m ) \vert .$$

17. The apparatus of claim 13, wherein the processor search for each of the frame structures by performing pseudonoise correlation.

18. The apparatus of claim 17, wherein the processor determines a decision statistic; and compares the decision statistic to a threshold for determining if the signal is present on selected channel.

19. The apparatus of claim 18,
wherein for the first frame structure, the decision statistic is
$${T}_{pnc , 1} = {max}_{0 \leq m \leq ⌈ {M}_{1} / {C}_{i} ⌉ - 1} \vert {t}_{pnc , 1} ( m ) \vert ;$$
wherein for the third frame structure, the decision statistic is
$${T}_{pnc , 3} = {max}_{0 \leq m \leq ⌈ {M}_{3} / {C}_{i} ⌉ - 1} \vert {t}_{pnc , 3} ( m ) \vert ; and$$
wherein for the second frame structure, the decision statistic is
$${T}_{pnc , 2} = {max}_{0 \leq m \leq {M}_{2} - 1} \vert {t}_{pnc , 2} ( m ) \vert .$$

20. The apparatus of claim 11, further comprising:
a memory for storing an available channel list to indicate that the selected channel is available for use if no signal is detected by the processor.
